(19) United States
(12) Patent Application Publication
(10) Pub. No.: US 2013/0118061 A1
(43) Pub. Date: May 16, 2013

(54) METHOD OF EXTRACTING TRIGLYCERIDES OR FATTY ACID METHYLESTERS FROM LIPIDS OF MICROALGAE BELONGING TO HETEROKONTOPHYTA OR HAPTOPHYTA AND METHOD OF PRODUCING BIODIESEL USING THE EXTRACTS

(71) Applicant: Korean Ocean Research And Development Institute, Ansan (KR)

(72) Inventors: Do Hyung Kang, Ansan (KR); Soo Jin Heo, Ansan (KR); Cheol Hong Oh, Jeju (KR); Se Jong Ju, Suwon (KR); Affan Abu, Ansan (KR); Dae Won Lee, Busan (KR); Min Ju Jung, Siheung (KR)

(73) Assignee: Korean Ocean Research And Development Institute, Ansan (KR)

(21) Appl. No.: 13/734,353

(22) Filed: Jan. 4, 2013

Related U.S. Application Data
(63) Continuation of application No. PCT/KR2010/009618, filed on Dec. 31, 2010.

(30) Foreign Application Priority Data
Jul. 7, 2010 (KR) 10-2010-0065613

(51) Int. Cl. C11B 1/10

(52) U.S. Cl. CPC C11B 1/10
USPC 44/388; 554/206

(57) ABSTRACT

Disclosed is a method of extracting fatty acid methyl esters as the main component of biodiesel from microalgae and producing biodiesel using the extracts. The method includes a process of extracting vegetable oil including triglyceride from microalgae; a process of adding a catalyst-containing alcohol to the extracted vegetable oil and transesterifying the oil while slowly heating the solution to a suitable temperature; a process of, after the completion of the transesterification, cooling the reaction product so as to be separated into crude biodiesel and the byproduct glycerol; a process of separating and washing the upper crude biodiesel layer; and a process of performing gas chromatography to analyze the content and yield of the washed biodiesel. A process for production of microalgae-derived biodiesel is provided and the process is very useful for producing microalgae-derived biodiesel that is more cost-effective than plant-derived biodiesel.

### CROSS-REFERENCE TO RELATED APPLICATIONS

This application is a continuation of International Application No. PCT/KR2010/009618 filed Dec. 31, 2010, which claims priority to Korean Application No 10-2010-0065613 filed Jul. 7, 2010, which applications are incorporated herein by reference.

### TECHNICAL FIELD

The present invention relates to a method of extracting vegetable oil from microalgae, producing fatty acid methyl esters as the main component of biodiesel from the extracted oil and producing biodiesel using the fatty acid methyl esters.

### BACKGROUND ART

The main energy sources that are currently being used in the world are fossil fuels accumulated over millions of years, such as petroleum, coal and natural gas, and the use thereof shows a tendency to increase rapidly due to the economic growth-oriented policies of each country. As the exhaustion of limited energy resources has been threatened due to the mass consumption of fossil fuels, the problems associated with disrupted oil supplies have become an issue. Also, the problems of global warming and environmental pollution resulting from the consumption of fossil fuels have come to the fore. For these reasons, studies on various types of energy sources capable of substituting for fossil fuels are being actively conducted in many countries. In Korea which relies on imports for most energy resources, many studies on the development of alternative energy are being conducted.

Recently, the development of renewable bio-energy that is a kind of alternative energy has significantly progressed. Biodiesel that is a kind of bio-energy is receiving a lot of attention due to its environmentally friendly characteristics.

Biodiesel is produced by transesterifying vegetable oils or animal fats with alcohols using various catalysts and reaction conditions. It is an energy source that has physical properties similar to those of petroleum diesel, and thus can be used directly in diesel vehicles or mixed with petroleum diesel for use in diesel vehicles. In addition, it is an environmentally friendly product containing oxygen in the molecule.

Such biodiesel is more expensive than petroleum diesel, but has advantages in that it has low toxicity and is biodegradable and in that the emission of fine dust and sulfur compounds therefrom upon combustion is greatly reduced. Moreover, since it is produced from renewable plant resources, it does not cause the problem of resource exhaustion and can be domestically supplied unlike petroleum diesel. Also, it can greatly contribute to a decrease in the emission of carbon dioxide, because carbon dioxide generated upon combustion thereof can be absorbed during the production of biomass. Accordingly, biodiesel can be regarded as clean fuel that can cope with the problems of global warming and environmental pollution.

Up to now, studies on biodiesel extraction have been conducted on various kinds of samples, including sunflower oil, Pongamia pinnata, Madhuca indica, and canola oil. However, if biodiesel is produced from land crops, the problems of grain price rises and food supply shortages can occur.

Meanwhile, microalgae produce organic compounds from inorganic compounds in the sea using solar energy, and their kinds are as varied as general microorganisms. Also, microalgae play an important role as primary producers. In addition, it has been found that their primary metabolites, such as proteins, carbohydrates and fats, are nutritionally valuable and their secondary metabolites have various functionalities. Thus, microalgae are used in a wide range of applications, including the food, pharmaceutical industry, cosmetic and shellfish fanning industries.

Although microalgae are significantly rich in proteins, the proteins can be classified as components that are obtained in relatively large amounts from microalgae. Microalgae are also significantly rich in lipids. The accumulation of lipids in microalgae is induced mainly by deficiency of nitrogen sources, and the content of lipids significantly differs depending on the kind of microalgae. Some macroalgal species having a lipid content of more than 70% have also been reported.

Biodiesel can be produced by extracting oil components in proportion to the content of lipids and subjecting the extracts to catalysis and transesterification.

Accordingly, the present inventors have studied various extraction, separation and analysis methods to produce biodiesel from microalgae and, as a result, have developed a method capable of producing a high yield of biodiesel from Nannochloropsis sp. or Isochrysis sp.

### SUMMARY OF THE DISCLOSURE

It is an object of the present invention to provide a method of extracting vegetable oil from microalgae and a method of producing biodiesel using the extract.

To achieve the above object, the present invention provides a method of extracting lipids for production of biodiesel, the method including the steps of:

1) freeze-drying either microalgae belonging to Heterokontophyta or Haptophyta or Scenedesmus sp. to obtain freeze-dried powder; and

2) adding an organic solvent to the freeze-dried powder and extracting lipids therefrom.

In the lipid extraction method of the present invention, step 2) is preferably carried out by adding the organic solvent and then extracting the lipids by centrifugation.

In the lipid extraction method of the present invention, the freeze drying is preferably carried out at a temperature of −100 to −60 ° C. and a pressure of 5 to 30 millitorr.

In the lipid extraction method of the present invention, the organic solvent is at least one selected from the group consisting of hexane, diethylether, dichloromethane, chloroform, methanol, ethanol, and mixtures thereof.

In the lipid extraction method of the present invention, step 2) includes the sub-steps of:

a) adding an organic solvent to the freeze-dried powder, followed by centrifugation to obtain supernatant A;

b) adding an organic solvent to the centrifuged residue, followed by centrifugation to obtain supernatant B; and

c) mixing supernatants A and B and centrifuging the supernatant mixture to extract lipids.

Herein, sub-step c) is preferably carried out by adding saline to the mixture of supernatants A and B, and then allowing the supernatant mixture to stand for 30 minutes to 2 hours, followed by centrifugation.

Preferably, the mixture of supernatants A and B is mixed with saline at a ratio of 2:1.

In the lipid extraction method of the present invention, the organic solvent in sub-steps a) and b) is preferably a mixture of chloroform and methanol.

Preferably, the mixing ratio of chloroform and methanol in the organic solvent is 1:2˜2:1.

The present invention also provides a method of producing biodiesel, including extracting lipids according to the above-described lipid extraction method, and then transesterifying the extracted lipids.

Herein, the transesterification is preferably carried out by adding alcohol and a base catalyst to the lipids and then transesterifying the lipids.

In the inventive method of producing microalgae-derived biodiesel, the alcohol is preferably at least one selected from the group consisting of methanol, ethanol, propanol, butanol, and mixtures thereof, and the catalyst is preferably sodium hydroxide or potassium hydroxide.

In the inventive method of producing microalgae-derived biodiesel, the alcohol is preferably added in an amount of 10-100% (w/w) relative to the weight of the lipids.

The inventive method of producing microalgae-derived biodiesel preferably additionally includes a step of allowing the transesterified product to stand until it reached room temperature to separate a biodiesel layer, and then washing the separated biodiesel layer 2-5 times with distilled water.

In the inventive method of producing microalgae-derived biodiesel, the transesterification is preferably carried out at a temperature of 50 to 70 ° C. for 2-5 hours.

The components of the microalgae-derived biodiesel separated according to the inventive method are analyzed by thin film chromatography, high-performance liquid chromatography and gas chromatography. More preferably, the fatty structure and fatty acid composition of the microalgae-derived biodiesel are analyzed by thin film chromatography-flame ionization detector (TLC-FID) and gas chromatography-flame ionization detector (GC-FID).

Microalgae used in the present invention have a higher content of lipids, which are converted into biodiesel, compared to plant materials, such as rapes, soybeans, palms, coconuts, Canola, and Jatropha, which have been used to produce biodiesel in the prior art. Also, a much higher yield of oil can be extracted from microalgae even in a smaller-sized area, and microalgae are easily cultivated due to their high growth rate. Thus, in coastal countries where plants for biodiesel cannot be cultivated, microalgae can be easily used as fuel. According to the present invention, in Korea, a non-oil producing country, the energy import dependence and the atmospheric emission of carbon dioxide can be reduced. Also, microalgae can be used as alternative resources for fossil fuels being depleted. Moreover, it is possible to solve the problems of rising grain prices and food supply shortages, which appear when land crops are used.

Furthermore, the organic solvent extraction method used in the present invention operates in a simple manner. Also, it requires low energy consumption, and thus incurs low cost, compared to existing high-temperature extraction methods and ultrahigh pressure extraction methods. In addition, microalgae-derived biodiesel that is obtained by transesterification has not yet been produced in Korea and can offer a role model for the production of microalgal biodiesel.

### BRIEF DESCRIPTION OF DRAWINGS

The above and other objects, features and advantages of the present invention will be more apparent from the following detailed description taken in conjunction with the accompanying drawings, in which:

FIG. 1 is a photograph showing a biodiesel layer (upper) and a glycerol layer (lower), obtained by extracting lipids from microalgae, adding the extracted lipids to alcohol containing a catalyst, and then transesterifying the lipids

FIG. 2 is a photograph showing biodiesel (left) and glycerol (right), obtained by washing the separated biodiesel layer and glycerol layer several times;

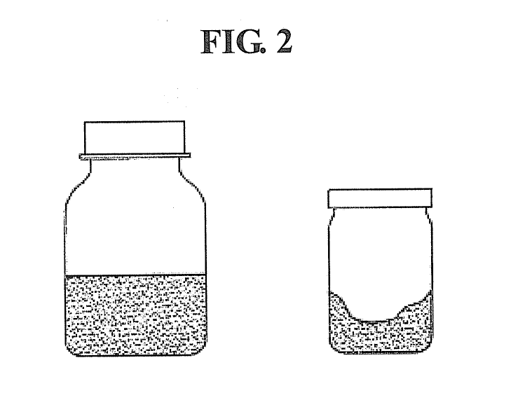

FIG. 3 shows the relative frequency of fatty acid methyl esters derived from microalgae; and

FIG. 4 is a flow chart showing a production process of separating biodiesel from microalgae.

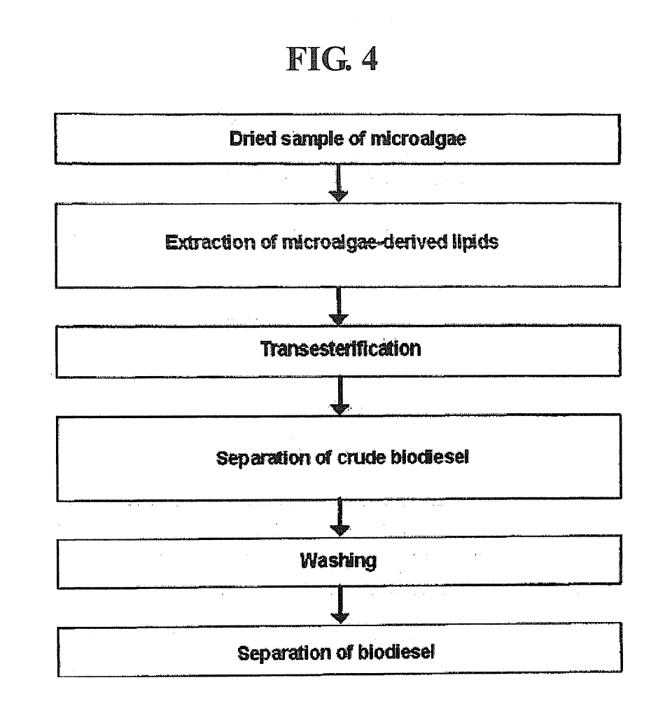

### DETAILED DESCRIPTION OF THE DISCLOSURE

Hereinafter, the present invention will be described in further detail with reference to examples. In the following examples, the following microalgae were used: the marine microalgae Nannochloropsis sp. belonging to Eukaryota, Kingdom Chromalveolata and Heterokontophyta Isochrysis sp. belonging to Haptophyta and the freshwater microalgae Scenedesmus sp. and Chlorella sp. belonging to Kingdom Plantae. It is to be understood, however, that these examples are for illustrative purposes only and the scope of the present invention is not limited thereto.

### EXAMPLES

### Example 1

### Extraction of Vegetable Fats From Microalgae

### Example 1-1

Powder (100 g), obtained by drying cultured microalgae in a freeze-dryer at a temperature of −88 ° C. and a pressure of 5 milltorr, was subjected to extraction. First, 1,500 ml of chloroform: methanol (1:2 v/v) was added to Nannochloropsis sp. powder, and the solution was extracted and then centrifuged to obtain a supernatant (A). To the residue, 1,500 ml of chloroform: methanol (1:2 v/v) was added, and the solution was extracted again and then centrifuged to obtain a supernatant (B). The obtained supernatant (B) was mixed with the supernatant (A). The mixture of the supernatants (A) and (B) was mixed with saline at a ratio of 2:1, left to stand at 4° C. for 1 hour, and then centrifuged, thereby extracting lipids.

### Example 1-2

Lipids were extracted in the same manner as Example 1-1, except that Isochrysis sp. was used.

### Example 1-3

Lipids were extracted in the same manner as Example 1-1, except that Scenedesmus sp. was used.

### Comparative Example 1

Lipids were extracted in the same manner as Example 1-1, except that Chlorella sp. was used.

TABLE 1

| Sample | Total lipid content (%) |
|---|---|
| Nannochloropsis sp. | 19.56 |
| Isochrysis sp. | 12.79 |
| Scenedesmus sp. | 2.97 |
| Chlorella sp. | 10.35 |

As can be seen in Table 1 above, Nannochloropsis sp. showed the highest lipid content of 19.56%, and Isochrysis sp. showed a relatively high lipid content of 12.79%.

### Example 2

### Analysis of Composition of Lipids Extracted From Microalgae

The major lipid groups obtained in Example 1 and Comparative Example 1 were analyzed by an Iatroscan Mark-V thin film chromatography-flame ionization detector. Specifically, a suitable amount (about 1-2 μ) of the extracted lipids was dropped on a Chroma load, and then focused with a mixed organic solvent (dichloromethane: methanol=1:1). Lipid groups were separated from the lipid sample using a non-polar organic solvent (hexane:diethylether: formic acid=85:15:0.2) and analyzed.

TABLE 2

| | Composition (%) of lipid groups | | |
|---|---|---|---|
| Sample | Phospholipid | Cholesterol | Other lipids ¹⁾ |
| Nannochloropsis sp. | 27.2 | 7.9 | 64.9 |
| Isochrysis sp. | 42.3 | 9.6 | 48.2 |
| Scenedesmus sp. | 34.5 | 14.9 | 50.6 |
| Chlorella sp. | 36.4 | ND | 63.6 |

¹⁾ free fatty acid, mono-diglycerides, wax, etc.

As can be seen in Table 2 above, Nannochloropsis sp. showed the highest content of the other lipids containing glycerides that are the main components of biodiesel.

### Example 3

### Separation of Biodiesel Components (Mono-, Di-, Triglycerides) From Microalgae

In order to separate biodiesel components (mono-, di-, triglycerides) from the lipids obtained in Example 1, transesterification was carried out. First, to the lipids obtained in Example 1, methanol containing sodium hydroxide as a catalyst was added at a ratio of 10-20:1relative to the lipids. The lipids were transesterified by stirring them at a temperature of 60° C. for 3 hours. After completion of the transesterification, the reaction product was placed in a separatory funnel and allowed to stand until it reached room temperature. As a result, it was found that the biodiesel components were separated.

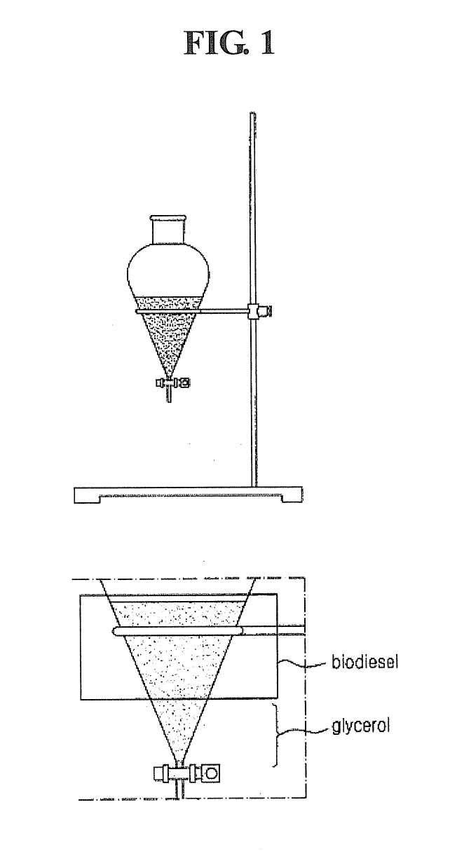

FIG. 1 shows the results of the experiment. As can be seen therein, when the reaction product resulting from the transesterification was placed in the separatory funnel and allowed to stand until it reached room temperature, it could be seen that the upper biodiesel layer was separated from the lower glycerol layer.

### Example 4

### Purification of Microalgal Biodiesel

After completion of the transesterification, the reaction product was placed in a separatory funnel and allowed to stand until it reached room temperature. Then, the upper biodiesel layer was washed 2-5 times with distilled water, thereby obtaining biodiesel.

### Example 5

### Analysis of Fatty Acid Content, Relative Frequency and Yield of Microalgal Biodiesel

The fatty acid content and relative frequency of the biodiesel obtained in Example 3 were analyzed using gas chromatography-flame ionization detector. Specifically, hydrochloric acid was added to the biodiesel solution to precipitate the sodium hydroxide, and then fatty acids were extracted from the solution using a mixed organic solvent (hexane: diethylether=9:1). The extracted fatty acids were esterified with BF₃/methanol to fatty acid methyl esters, which were then separated and analyzed by gas chromatography-flame ionization detector.

TABLE 3

| | Total content | Content ratio of FAME (%) | |
|---|---|---|---|
| | of FAME²⁾ | 16 carbon | 18 carbon |
| Sample | (mg/g) | atoms or more | atoms or more |
| Nannochloropsis sp. | 169.56 | 97.7 | 56.2 |
| Isochrysis sp. | 68.17 | 98.0 | 41.3 |
| Scenedesmus sp. | 9.54 | 74.9 | 74.9 |
| Chlorella sp. | 27.60 | 99.0 | 59.1 |

²⁾Fatty acid methyl esters

Table 3 above shows the results of analyzing the fatty acid methyl ester content of the microalgae-derived biodiesel. As can be seen therein, the fatty acid methyl ester content was highest as 169.56 mg/g for Nannochloropsis sp., and 68.17 mg/g for Isochrysis sp. Also, the content ratio of the fatty acid methyl ester of 16 carbon atoms or more, which is a factor determining the quality of biodiesel, was more than 97% for Nannochloropsis sp., and the content ratio of the fatty acid methyl ester of 18 carbon atoms or more was 56.2, 41.3 and 74.9% for Nannochloropsis sp., Isochrysis sp. and Scenedesmus sp.

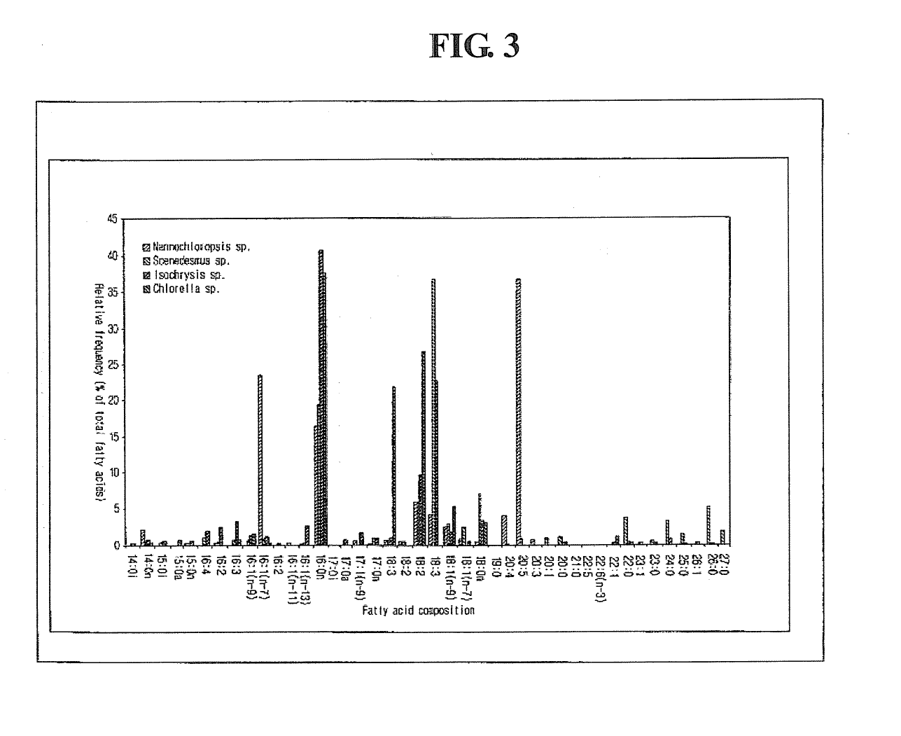

FIG. 3 shows the relative frequency of microalgal fatty acid methyl ester. As can be seen therein, Nannochloropsis sp. showed the highest relative frequency of 36.62% at 20:5, and the relative frequency for Nannochloropsis sp. was higher in the order of 16:1(n-7), 16:0 n, 18:2, etc. Scenedesmus sp. showed the highest relative frequency of 36.81% at 18:3, and the relative frequency for Scenedesmus sp. was higher in the order of 16:0 n, 18:0 n and 18:2. Isochrysis sp. showed the highest relative frequency of 40.58% at 16:0 n, and the relative frequency for Isochrysis sp. was higher in the order of 18:3, 18:2, 18:0 n, etc. In addition, Chlorella sp. showed the highest relative frequency of 37.44% at 16:0 n, and the relative frequency for Chlorella sp. was higher in the order of 18:2, 18:3, 18:1(n-9), etc.

TABLE 4

| Sample | Biodiesel yield (%) |
|---|---|
| Nannochloropsis sp. | 86.7 |
| Isochrysis sp. | 53.3 |
| Scenedesmus sp. | 32.1 |
| Chlorella sp. | 26.7 |

Table 4 above shows the results of analyzing the yield of the microalgae-derived biodiesel. As can be seen therein, Nannochloropsis sp. showed the highest yield of 86.7%, Isochrysis sp. the yield of 53.3%, and Scenedesmus sp. the yield of 32.1%.

As described above, the present invention succeeded in separating microalgae-derived biodiesel by optimizing various extraction, separation and analysis methods in order to produce biodiesel from microalgae.

While the present invention has been described with reference to exemplary embodiments thereof, it will be understood by those skilled in the art that the present disclosure is not limited to such exemplary embodiments and that various changes may be made without departing from the scope of the invention. In addition, a variety of modifications, enhancements, and/or variations may be made to adapt a particular situation or material to the teachings of the present invention without departing from the essential spirit or scope thereof. Therefore, it is intended that the present invention not be limited to the particular embodiment disclosed as the best mode contemplated for carrying out the present invention, but that the invention will include all embodiments falling within the scope of the appended claims.

1. A method of extracting lipids for production of biodiesel, the method comprising the steps of: 1) freeze-drying either microalgae belonging to Heterokontophyta or Haptophyta or Scenedesmus to obtain freeze-dried powder; and 2) adding an organic solvent to the freeze-dried powder and extracting lipids therefrom.

2. The method of claim 1, wherein step 2) is carried out by adding the organic solvent and then extracting the lipids by centrifugation.

3. The method of claim 1, wherein the freeze drying is carried out at a temperature of −100 to −60 ° C.

4. The method of claim 1, wherein the freeze drying is carried out at a pressure of 5 to 30 millitorr.

5. The method of claim 1, wherein the organic solvent is at least one selected from the group consisting of hexane, diethylether, dichloromethane, chloroform, methanol, ethanol, and mixtures thereof.

6. The method of claim 2, wherein step 2) comprises the sub-steps of: a) adding an organic solvent to the freeze-dried powder, followed by centrifugation to obtain supernatant A; b) adding an organic solvent to the centrifuged residue, followed by centrifugation to obtain supernatant B; and c) mixing supernatants A and B and centrifuging the mixture to extract lipids.

7. The method of claim 6, wherein sub-step c) is carried out by adding saline to the mixture of supernatants A and B, and then allowing the mixture to stand for 30 minutes to 2 hours, followed by centrifugation.

8. The method of claim 7, wherein the mixture of supernatants A and B is mixed with saline at a ratio of 2:1.

9. The method of claim 6, wherein the organic solvent in sub-steps a) and b) is a mixture of chloroform and methanol.

10. The method of claim 9, wherein the mixing ratio of chloroform and methanol is 1:2˜2:1.

11. The method of claim 1, wherein the microalgae are at least one selected from the group consisting of Nannochloropsis gaditana, Nannochloropsis Granulata, Nannochloropsis Limnetica, Nannochloropsis Oceanica, Nannochloropsis salina, Chlysotila sp., Dicrateria sp., Emilianiasp., Gephyrocapsa sp. and Isochrysis sp.

12. A method of producing biodiesel, comprising extracting lipids according to the method of claims 1 and then transesterifying the extracted lipids.

13. The method of claim 12, wherein the transesterification is carried out by adding alcohol and a base catalyst to the extracted lipids and then transesterifying the lipids.

14. The method of claim 13, wherein the alcohol is at least one selected from the group consisting of methanol, ethanol, propanol, butanol, and mixtures thereof, and the catalyst is sodium hydroxide or potassium hydroxide.

15. The method of claim 13, wherein the alcohol is added in an amount of 10-100% (w/w) relative to the weight of the lipids.

16. The method of claim 12, further comprising a step of allowing the transesterified product to stand until it reached room temperature so as to separate a biodiesel layer, and then washing the separated biodiesel layer 2-5 times with distilled water.

17. The method of claim 12, wherein the transesterification is carried out at a temperature of 50 to 70° C. for 2-5 hours.
